(19) United States
(12) Patent Application Publication
(10) Pub. No.: US 2011/0278131 A1
(43) Pub. Date: Nov. 17, 2011

(54) LOW-COST SHEET METAL CLUTCH HOUSING FOR A FRICTION CLUTCH

(75) Inventors: Martin P. Keating, Plainfield, IL (US); Kenneth C. Yuergens, Farmington Hills, MI (US); Yosuke Kimpara, Fukuroi-city (JP); Keith Honkala, Shelby Township, MI (US)

(73) Assignee: BORGWARNER INC., Auburn Hills, MI (US)

(21) Appl. No.: 13/019,355

(22) Filed: Feb. 2, 2011

Related U.S. Application Data
(60) Provisional application No. 61/333,847, filed on May 12, 2010.

(51) Int. Cl. F16D 13/58; B23P 17/00

(52) U.S. Cl. 192/112; 29/428

(57) ABSTRACT

A clutch has an outer housing and an inner housing arranged coaxially with respect to one another to support a plurality of first and second alternating, interiorly arranged, radially extending, friction members for axial movement between engaged and disengaged positions. The outer housing can have a longitudinally extending cylindrical side wall and a radially inwardly extending end wall. A plurality of longitudinally extending, teeth-receiving notches can be formed at evenly angularly spaced locations along the cylindrical side wall. Each notch can have radially inwardly bent wall portions extending longitudinally to define teeth-receiving sidewalls of the outer housing. The inner housing assembly can have a hub and an elongate sheet metal strip having bent tabs and evenly spaced corrugations stamped along an entire longitudinal length. The strip can be wrapped around to form a continuous, generally cylindrical, corrugated ring with inwardly extending bent tabs connected to the hub.

### CROSS-REFERENCE TO RELATED APPLICATIONS

This application is a continuation and claims the benefit under 35 U.S.C. §119 (e) of U.S. Provisional Patent Application Ser. No. 61/333,847 filed on May 12, 2010, which is incorporated by reference herein in its entirety.

### FIELD OF THE INVENTION

The invention relates to a power-transmitting clutch using friction or interlocking parts for securing and releasing driving continuity as between two shafts, or a pulley and a shaft, or other driving and driven parts.

### BACKGROUND

A power-transmitting clutch can include an input shaft and an output shaft rotatable about a common axis. At least three members can be supported thereby in an array of adjacent members spaced along the axis and co-axial with the shafts. The outer of the members can have surfaces facing opposite surfaces of one or more intermediate members. One of the members can be constrained to rotate with one of the shafts, while another of the members can be constrained to rotate with the other of the shafts while being movable along the common axis. The clutch can also have a mechanism for moving the members toward one another for mutual engagement of the facing surfaces, whereby the input shaft transmits rotation to the output shaft when the facing surfaces are mutually engaged. The mechanism can transmit rotational force from an input shaft to a member supported thereby, or can transmit rotational force from another member to an output shaft that supports the other member. The mechanism simultaneously permits movement of either member relative to the corresponding supporting shaft. The mechanism can include portions integral with or secured to either shaft extending along or parallel to the axis of rotation thereof which portions connect the member to the corresponding supporting shaft for rotation and permit movement only in a direction parallel to the axis. The portions of the mechanism can include gear-like teeth and grooves in the shaft or drum mating with complementary grooves and teeth in the member, which can also be described as ribs or slots in the shaft or drum mating with complementary slots and protrusions in the member. A plurality of first members can be in torque-transmitting connection with an input shaft, a plurality of second members can be in torque-transmitting connection with an output shaft coaxial with the input shaft, and wherein the first and second members alternate with one another along the axis of the shafts.

### SUMMARY

An improvement to a power-transmitting clutch can include a clutch housing/disc carrier made from sheet metal with a generally cylindrical housing wall disposed at a radial distance from a longitudinal axis for the housing. At least one opening in the housing wall can be operatively arranged to accept at least a portion of a clutch plate/disc for the clutch assembly. The housing can be cylindrical, and the slots or openings can extend substantially parallel to the axis. This configuration can provide a clutch mechanism of a multiple plate/disc type which is simple in construction and comparatively inexpensive to manufacture.

A clutch can include an outer housing and an inner housing arranged coaxially with respect to one another to support a plurality of first and second alternating, interiorly arranged, radially extending, friction members for axial movement between engaged and disengaged positions. The outer housing can have a longitudinally extending cylindrical side wall and a radially inwardly extending end wall, and a plurality of longitudinally extending, teeth-receiving notches formed at evenly angularly spaced locations along the cylindrical side wall. Each notch can have radially inwardly bent wall portions extending longitudinally to define teeth-receiving sidewalls of the outer housing for receiving corresponding teeth portions of one of the first and second plurality of friction members.

A method for manufacturing a clutch having an outer housing and an inner housing arranged coaxially with respect to one another to support a plurality of first and second alternating, interiorly arranged, radially extending, friction members for axial movement between engaged and disengaged positions can include providing a hub, providing an elongate sheet metal strip, stamping corrugations along an entire longitudinal length of the sheet metal strip, rehitting a portion of the corrugated sheet metal strip to wrap the corrugated sheet metal strip into a generally cylindrical, corrugated ring, and connecting the corrugated ring to the hub to define at least one housing of the clutch.

A clutch can have an outer housing and an inner housing arranged coaxially with respect to one another to support a plurality of first and second alternating, interiorly arranged, radially extending, friction members for axial movement between engaged and disengaged positions. The clutch can include an inner housing assembly having a hub and an elongate sheet metal strip having bent tabs and evenly spaced corrugations stamped along an entire longitudinal length of the sheet metal strip. The elongate sheet metal strip can be wrapped around to form a continuous, generally cylindrical, corrugated ring with inwardly extending bent tabs. The corrugated ring can be connected to the hub.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a partial cross-sectional view of a power-transmitting clutch having a notched drawn sheet metal outer housing and an inner housing defined by a metal strip formed with a plurality of splines and riveted to a hub for assembly with a plurality of clutch plates or discs extending therebetween;

FIG. 2A is a cross-sectional view of the outer housing of FIG. 1;

FIG. 2B is a partial cross-sectional view of the outer housing with multiple plates or discs taken as shown in FIG. 2A;

FIG. 2C is a perspective view of the outer housing assembled with multiple plates or discs and a snap ring;

FIG. 3A is a plan view of the outer housing of FIGS. 1-2C;

FIG. 3B is a cross-sectional view of the outer housing taken as shown in FIG. 3A;

FIG. 3C is a perspective view of the outer housing of FIGS. 3A-3B;

FIG. 4A is a plan view of a notched drawn sheet metal outer housing having increased material thickness and fewer spline notches formed therein;

FIG. 4B is a cross-sectional view of the outer housing taken as shown in FIG. 4A;

FIG. 4C is a perspective view of the outer housing of FIGS. 4A-4B;

FIG. 5A is a detail view of a notch and an alternative snap ring;

FIG. 5B is a perspective view of a snap ring for holding the multiple plates or discs in assembly with the outer housing;

FIG. 6A is a perspective view of the outer housing of FIGS. 4A-4C with a fluid cover for reducing an amount of fluid escaping from the outer housing;

FIG. 6B is a detail view of the fluid cover of FIG. 6A;

FIG. 7A is a plan view of an inner housing hub;

FIG. 7B is a cross-sectional view of the inner housing hub taken as shown in FIG. 7A;

FIG. 7C is a detail view of the inner housing hub taken as shown in FIG. 7A;

FIG. 8A is a plan view an elongate flat metal strip prior to forming corrugations therein;

FIG. 8B is a side view of the metal strip of FIG. 8A having bent tabs and corrugations formed therein;

FIG. 8C is a side view of the metal strip of FIGS. 8A-8B after forming bent tabs and corrugations along an entire longitudinal length of the metal strip;

FIG. 8D is a side view of the metal strip of FIGS. 8A-8C being rehit along four corrugations so that the metal strip wraps around to form a ring;

FIG. 9A is a plan view of an assembly of the corrugated metal strip ring to the inner hub;

FIG. 9B is a cross-sectional view of inner hub assembly taken as shown in FIG. 9A;

FIG. 9C is a perspective view of the inner hub assembly of FIGS. 9A-9B;

FIG. 10A is a partial detail view of the corrugated sheet metal strip ring prior to assembly to the hub; and

FIG. 10B is a partial detail view of the corrugated sheet metal strip ring after assembly to the hub.

### DETAILED DESCRIPTION

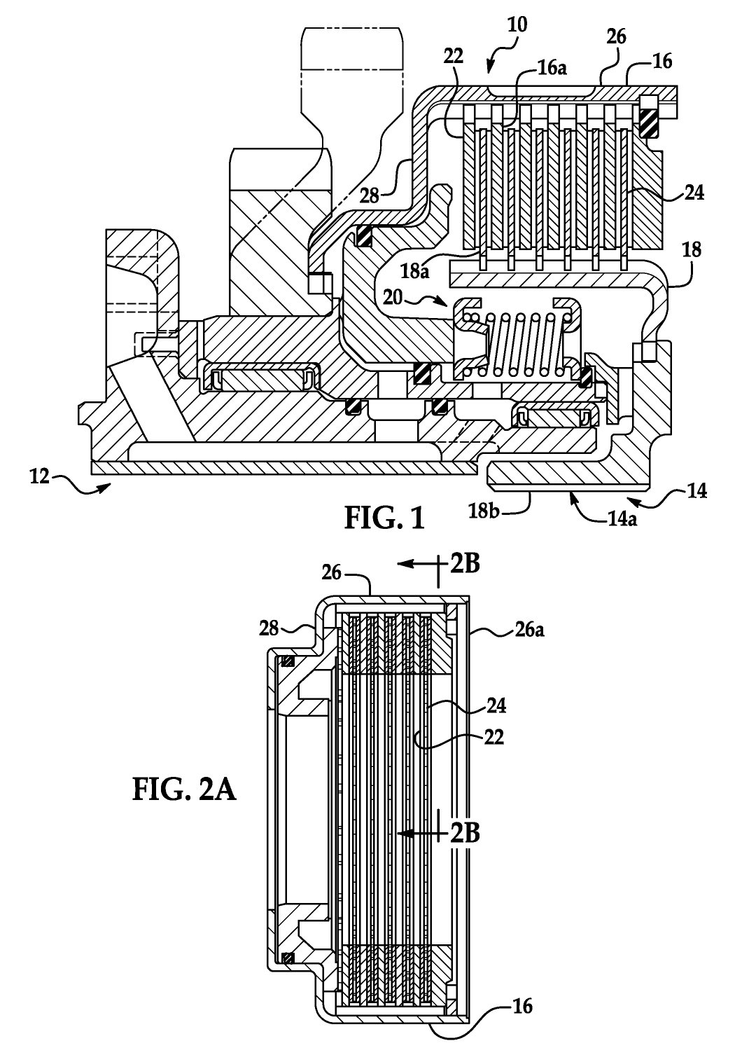

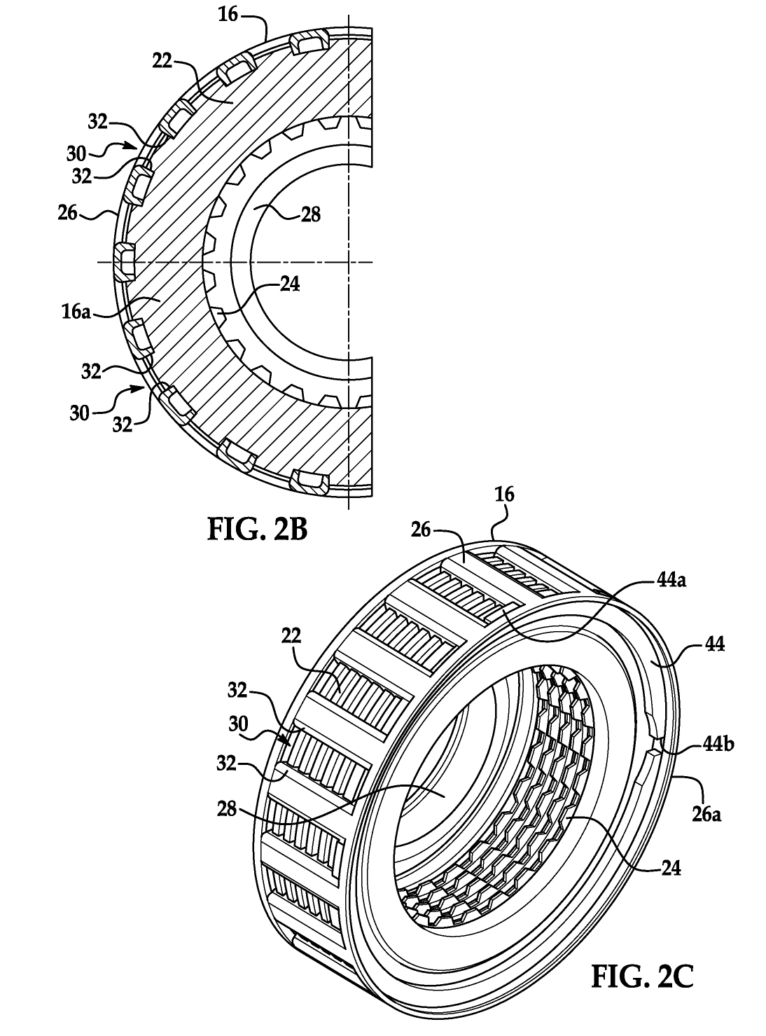

Referring now to FIGS. 1 and 2A-2C, a power-transmitting clutch 10 can include an input shaft 12 and an output shaft 14 rotatable about a common axis. At least three members 16, 18, 20 can be supported thereby in an array of adjacent members spaced along the axis and co-axial with the shafts 12, 14. The outer housing 16 of the members can have plate or disc surfaces 16a facing opposite plate or disc surfaces 18a of one or more intermediate members associated with the inner housing 18. One of the members, such as outer housing 16, can be constrained to rotate with one of the shafts 12, while another of the members, such as inner housing 18, can be constrained to rotate with the other of the shafts 14 while being movable along the common axis. The clutch 10 can also have a mechanism 20 for moving the members toward one another for mutual engagement of the facing surfaces 16a, 18a, whereby the input shaft 12 transmits rotation to the output shaft 14 when the facing surfaces 16a, 18a are mutually engaged. The mechanism 20 can transmit rotational force from an input shaft 12 to an outer housing member 16 supported thereby, or can transmit rotational force from another member, such as inner housing 18, to an output shaft 14 that supports the other member 18. The mechanism 20 simultaneously permits movement of either member 16, 18 relative to the corresponding supporting shaft 12, 14. The mechanism 20 can include portions integral with or secured to either shaft 12, 14 extending along or parallel to the axis of rotation thereof which portions connect the member 16, 18 to the corresponding supporting shaft 12, 14 for rotation and permit movement only in a direction parallel to the axis. The portions of the mechanism 20 can include gear-like teeth and grooves 14a in the drum or shaft 14 mating with complementary grooves and teeth 18b in the member 18, which can also be described as ribs or slots in the drum or shaft 12, 14 mating with complementary slots and protrusions in the member 16, 18. A plurality of first members 22 can be in torque-transmitting connection with an input shaft 12, a plurality of second members 24 can be in torque-transmitting connection with an output shaft 14 coaxial with the input shaft 12, and wherein the first and second members 22, 24 alternate with one another along the axis of the shafts 12, 14.

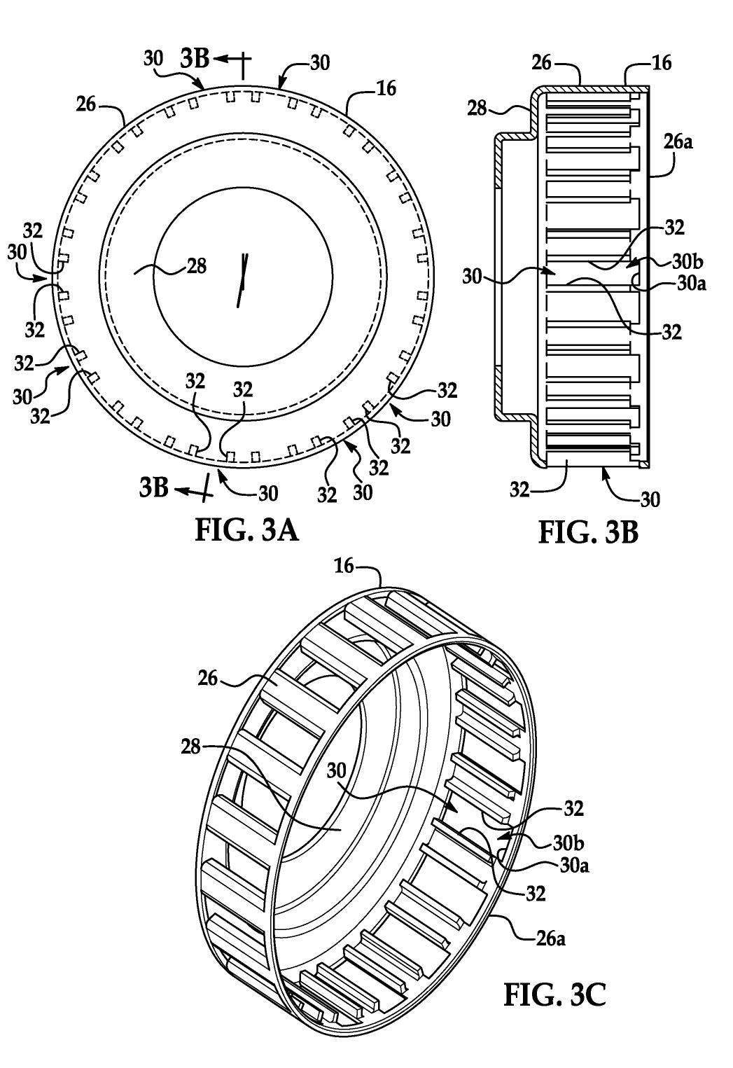

Referring now to FIGS. 3A-3C, the clutch 10 can include a drawn sheet metal outer housing 16 having a longitudinally extending cylindrical side wall 26 and a radially inwardly extending end wall 28. A plurality of laser-cut, longitudinally extending, teeth-receiving notches 30 can be formed at evenly angularly spaced locations along the cylindrical side wall 26. Each notch 30 can have radially inwardly bent wall portions 32 extending longitudinally to define teeth-receiving sidewalls of the outer housing 16. The inwardly bent wall portions 32 can extend along a portion of a longitudinal length of each notch 30 ending short of an outer end 30a of each notch 30 opposite from the end wall 28 to define an open slot 30b. As best seen in FIGS. 1, 2A, 2C, and 5B, a snap ring 44 can be engageable within the open slot 30b for retaining the plurality of first and second alternating, interiorly arranged, radially extending, friction members 22, 24 within the outer and inner housings 16, 18. Alternatively, as illustrated in FIG. 5A, a radially inwardly projecting protrusion 46 can be formed between an outer end 30a of each notch 30 and an outer end 26a of the cylindrical side wall 26 opposite from the end wall 28 to define a snap ring retaining member 46 for retaining the plurality of first and second alternating, interiorly arranged, radially extending, friction members 22, 24 within the outer and inner housings 16, 18.

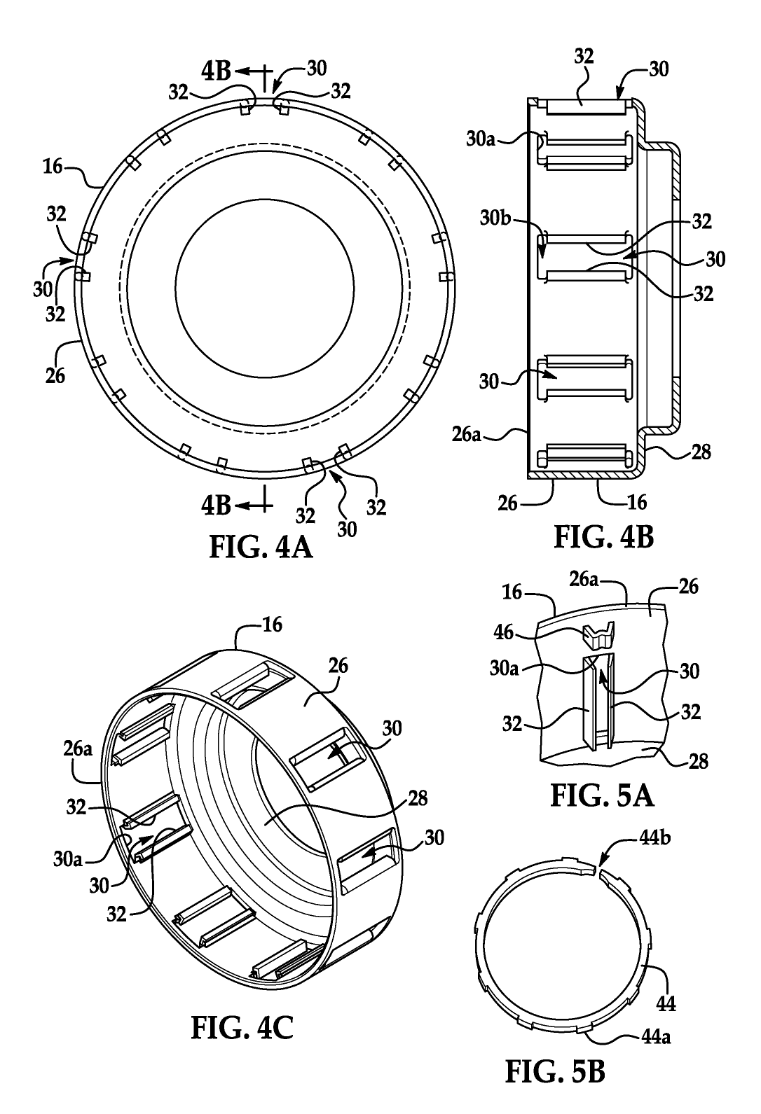

Referring now to FIGS. 4A-4C, an alternate configuration of outer housing 16 is illustrated. The outer housing 16 can include cylindrical side wall 26 and radially inwardly extending end wall 28. In this configuration, a thickness of the material defining the outer housing 16 is increased, by way of example and not limitation, such as from a thickness of 2.0 mm to a thickness of 2.5 mm, and fewer spline teeth or notches 30 are provided, by way of example and not limitation, such as nine spline teeth or notches 30 in place of the previously illustrated eighteen spline teeth or notches 30. This configuration of the outer housing 16 is believed to reduce finite element analysis stress values. Each notch 30 can have radially inwardly bent wall portions 32 extending longitudinally to define teeth-receiving sidewalls of the outer housing 16. The inwardly bent wall portions 32 can extend along a portion of a longitudinal length of each notch 30 ending short of an outer end 30a of each notch 30 opposite from the end wall 28 to define an open slot 30b. A snap ring 44 can be engageable within the open slot 30b for retaining the plurality of first and second alternating, interiorly arranged, radially extending, friction members 22, 24 within the outer and inner housings 16, 18.

Referring now to FIG. 5A, in either case, i.e. the configuration of FIGS. 3A-3C or the configuration of 4A-4C, a radially inwardly projecting protrusion 46 can be formed between an outer end 30a of each notch 30 and an outer end 26a of the cylindrical side wall 26 opposite from the end wall 28 to define a snap ring retaining member 46 for retaining the plurality of first and second alternating, interiorly arranged, radially extending, friction members 22, 24 within the outer and inner housings 16, 18. This configuration can replace the open slot 30b defined in each notch 30 previously described. A snap ring 44 can be engageable on a longitudinally inner side of the protrusion 46 with respect to the end wall 28 for retaining the plurality of first and second alternating, interiorly arranged, radially extending, friction members 22, 24 within the outer and inner housings 16, 18.

Referring now to FIG. 5B, the snap ring 44 is illustrated having a plurality of outwardly extending tabs or teeth 44a for engagement within the open slot 30b defined as a portion of each notch 30. An opening 44b in the periphery of the snap ring 44 allows the snap ring 44 to be assembled and disassembled with respect to the outer housing 16.

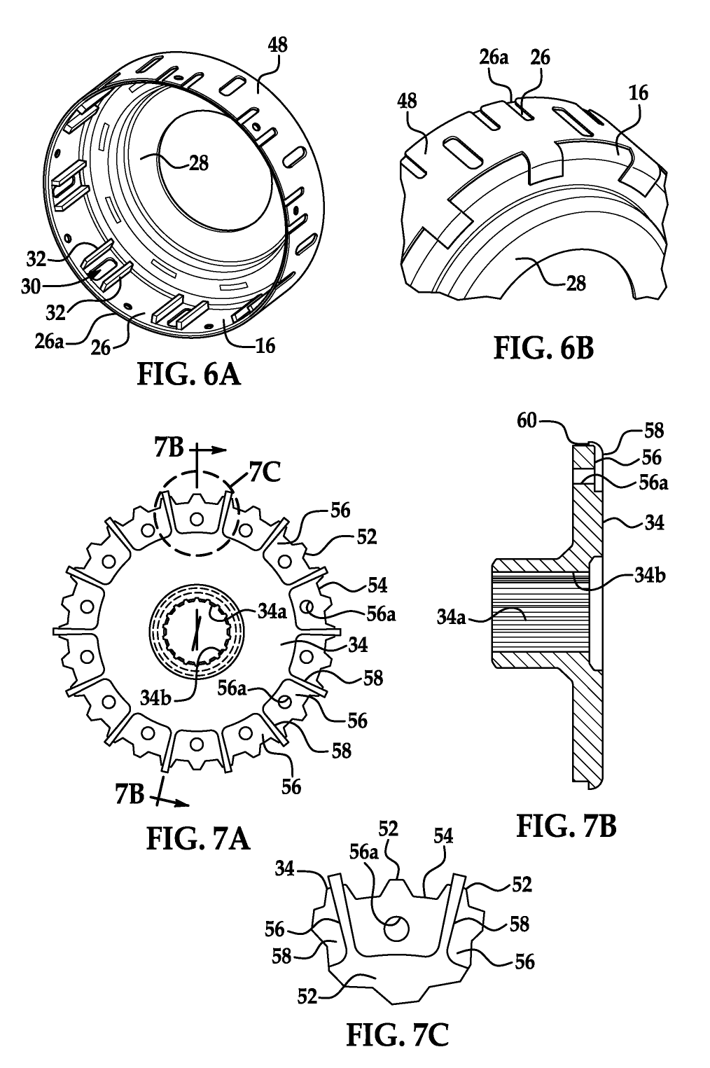

Referring now to FIGS. 6A-6B, an optional fluid cover 48 is illustrated. The fluid cover 48 can be formed of either sheet metal or plastic material, and can be attached to the external surface of the cylindrical side wall 26 of the outer housing 16. The fluid cover 48 can be added to the outer housing 16 if needed to further reduce the amount of fluid escaping through the notches 30 in the cylindrical side wall 26 of the outer housing 16. The fluid cover 48 can at least partially close the notches 30 formed in the cylindrical side wall 26 of the outer housing 16 to reduce the amount of fluid escaping from the outer housing 16.

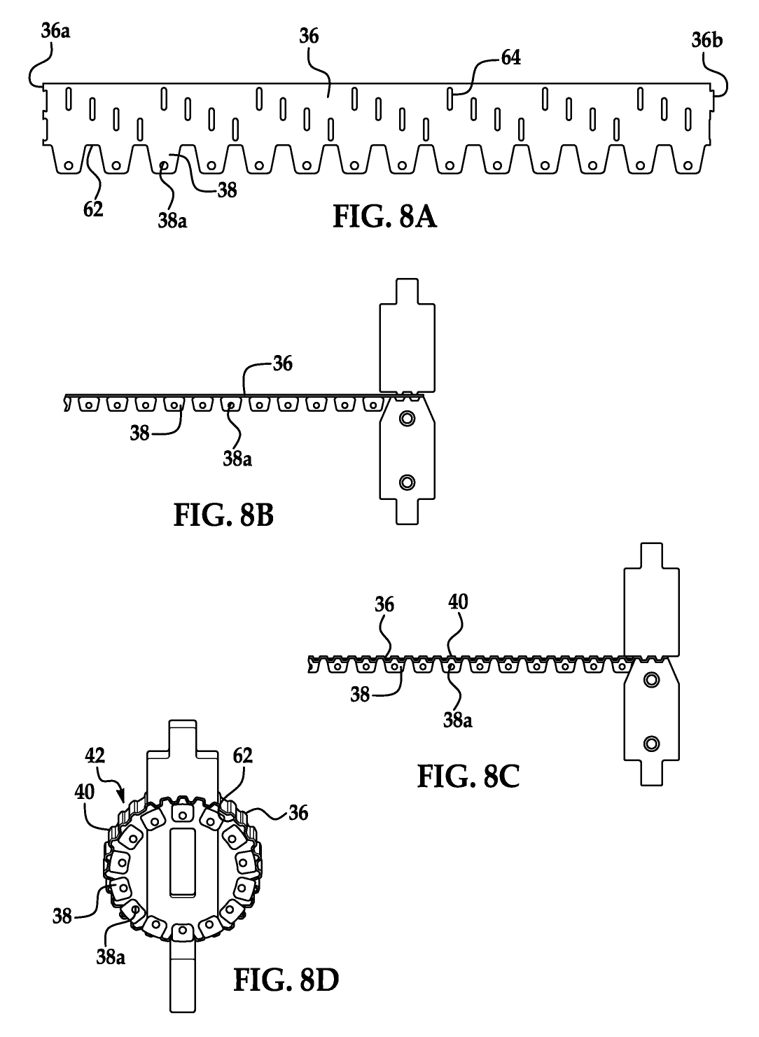

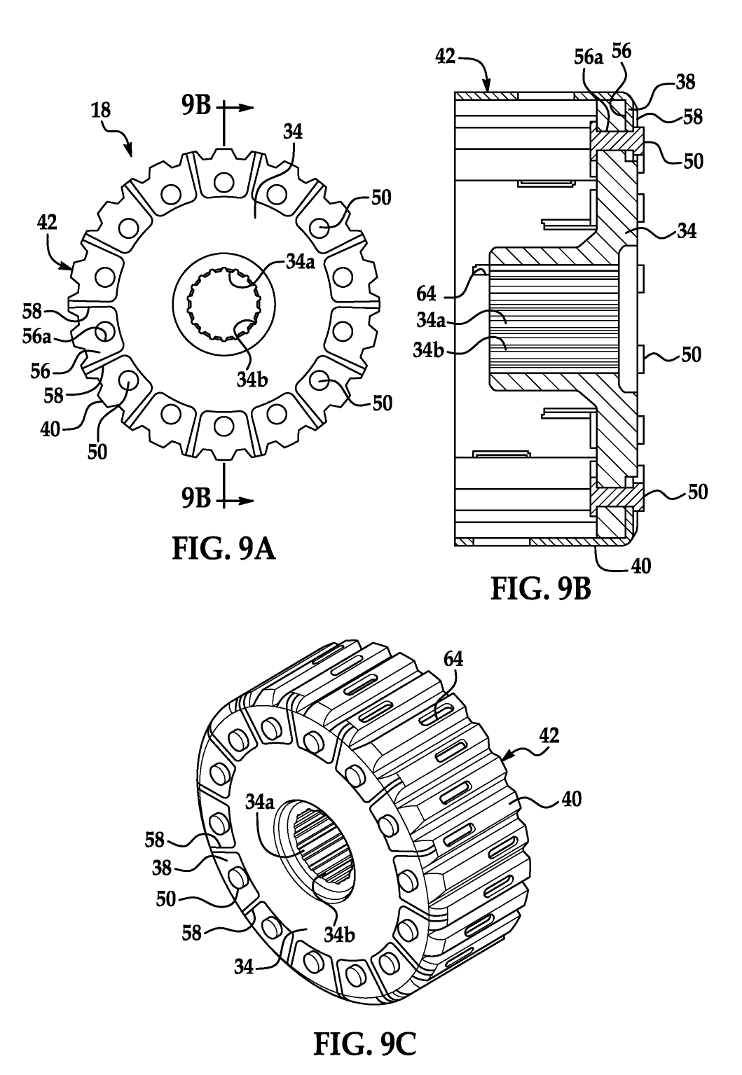

Referring now to FIGS. 7A-7C, an inner housing assembly 18 can include a hub 34 having a plurality of teeth 52 formed in an outer circumferential surface 54 of the hub 34. The hub 34 can include a plurality of splines 34a extending longitudinally along an inner surface 34b for operable engagement with corresponding splines formed on the output shaft 14. The hub 34 can be made from powdered metal, if desired. The hub 34 can include a plurality of complementary shaped recesses 56 for receiving bent tabs 38 of the corrugated ring 42, best seen in FIGS. 8A-8D, when the corrugated ring 42 is assembled with respect to the hub 34. A radially and longitudinally extending rib 58 is located between adjacent complementary shaped recesses 56 defining a longitudinal stop 60, best seen in FIG. 7B, for abutment with a longitudinal end 62 of the corrugated ring 42 located between adjacent bent tabs 38, best seen in FIGS. 8A and 9C. An aperture 56a is formed in each complementary shaped recess 56 for receiving a fastener, by way of example and not limitation, such as a rivet 50, extending therethrough for attaching the corrugated ring 42 to the hub 34, as will be described in greater detail below.

Referring now to FIGS. 8A-8D, an elongate sheet metal strip 36 is illustrated being formed into a continuous, generally cylindrical corrugated ring 42. As best seen in FIG. 8A, an elongate sheet metal strip 36 can have outwardly extending tabs 38 with an aperture 38a formed therein for receiving a fastener, by way of example and not limitation, such as a rivet 50. The tabs 38 can be bent at a ninety degree angle with respect to the strip 36 as best seen in FIG. 8B. In FIG. 8B, the strip 36 is at the start of a stamping process to form evenly spaced corrugations 40 stamped along an entire longitudinal length of the sheet metal strip 36 as best seen in FIG. 8C. The elongate sheet metal strip 36 can then be wrapped around to form a continuous, generally cylindrical, corrugated ring 42 with inwardly extending bent tabs 38, as best seen in FIG. 8D by rehitting or restamping a portion of the corrugations 40. Longitudinal ends 36a, 36b of the sheet metal strip 36 can be joined to one another, by way of example and not limitation, such as by laser welding, to form the generally cylindrical, corrugated ring 42 into a continuous corrugated ring 42. It should be recognized that the tabs 38 can be bent into the desired angular form either before or after formation of the corrugations 40, and can be formed either before or after assembly of the corrugated ring 42 to the hub 34, depending on the particular manufacturing and assembly process to be used. The corrugated ring 42 can be connected to the hub 34.

Referring now to FIGS. 9A-9C, an assembled inner housing 18 is illustrated. To assemble the corrugated ring 42 to the hub 34, the bent tabs 38 can be positioned within the complementary shaped recesses 56 to align apertures 38a with apertures 56a for receiving a fastener, by way of example and not limitation, such as a rivet 50, extending therethrough. After assembly of the corrugated ring 42 to the hub 34, a radially and longitudinally extending rib 58 located between adjacent complementary shaped recesses 56 defines a longitudinal stop 60, best seen in FIG. 7B, for abutment with a longitudinal end 62 of the corrugated ring 42 located between adjacent bent tabs 38, best seen in FIGS. 8A and 9C.

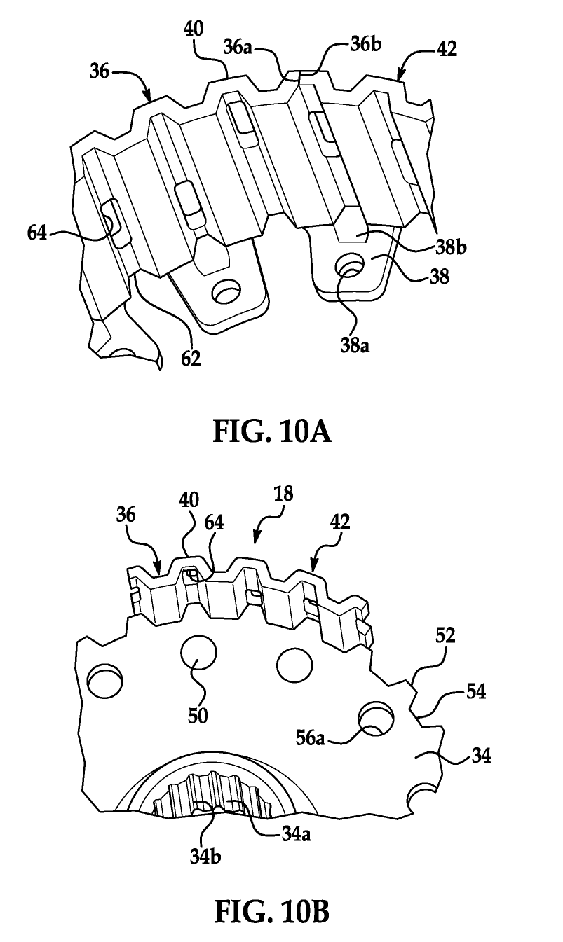

Referring now to FIGS. 10A-10B, details of the corrugated ring 42 and hub 34 of the inner housing assembly 18 are illustrated. As best seen in FIG. 10A, the corrugated ring 42 can include a full tab 38b for added strength. Longitudinal ends 36a, 36b of the sheet metal strip 36 can be joined to one another, by way of example and not limitation, such as by laser welding, to form the generally cylindrical, corrugated ring 42 into a continuous corrugated ring 42. Fluid flow apertures 64 can be provided in the corrugated ring 42 as desired to accommodate fluid flow between the inner and outer housings 16, 18. As best seen in FIG. 10B, the splines or teeth 52 formed in an outer circumferential surface 54 of the hub 34 extend within the corrugations 40 formed in the corrugated ring 42 to assist with carrying the torque load.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. In a clutch having an outer housing and an inner housing arranged coaxially with respect to one another to support a plurality of first and second alternating, interiorly arranged, radially extending, friction members for axial movement between engaged and disengaged positions, the improvement of the clutch comprising:
an outer housing having a longitudinally extending cylindrical side wall and a radially inwardly extending end wall, a plurality of longitudinally extending, teeth-receiving notches formed at evenly angularly spaced locations along the cylindrical side wall, each notch having radially inwardly bent wall portions extending longitudinally to define teeth-receiving sidewalls of the outer housing.

2. The improvement of claim 1, wherein the radially inwardly bent wall portions extend along a portion of a longitudinal length of each notch ending short of an outer end of each notch opposite from the end wall to define an open slot.

3. The improvement of claim 2 further comprising:
a snap ring engageable within the open slot for retaining the plurality of first and second alternating, interiorly arranged, radially extending, friction members within the outer and inner housings.

4. The improvement of claim 1 further comprising:
a radially inwardly projecting protrusion formed between an outer end of each notch and an outer end of the cylindrical side wall opposite from the end wall to define a snap ring retaining member for retaining the plurality of first and second alternating, interiorly arranged, radially extending, friction members within the outer and inner housings.

5. The improvement of claim 1 further comprising:
a fluid cover engageable with the outer housing and at least partially closing the notches formed in the cylindrical side wall of the outer housing for reducing fluid flow escaping from the outer housing.

6. The improvement of claim 1 further comprising:
an inner housing assembly having a hub and an elongate sheet metal strip having bent tabs and evenly spaced corrugations stamped along an entire longitudinal length of the sheet metal strip, the elongate sheet metal strip wrapped around to form a continuous, generally cylindrical, corrugated ring with inwardly extending bent tabs, the corrugated ring connected to the hub.

7. The improvement of claim 6 further comprising:
at least one rivet attaching a bent tab of the corrugated ring to the hub.

8. The improvement of claim 6 further comprising:
a plurality of teeth formed in an outer circumferential surface of the hub for supporting the corrugated ring when assembled.

9. The improvement of claim 6, wherein the hub includes a plurality of complementary shaped recesses for receiving the bent tabs of the corrugated ring when assembled.

10. The improvement of claim 9 further comprising:
a radially and longitudinally extending rib located between adjacent complementary shaped recesses defining a longitudinal stop for abutment with a longitudinal end of the corrugated ring located between adjacent bent tabs.

11. A method for manufacturing a clutch having an outer housing and an inner housing arranged coaxially with respect to one another to support a plurality of first and second alternating, interiorly arranged, radially extending, friction members for axial movement between engaged and disengaged positions, the method comprising:
providing a hub;
providing an elongate sheet metal strip;
stamping corrugations along an entire longitudinal length of the sheet metal strip;
rehitting a portion of the corrugated sheet metal strip to wrap the corrugated sheet metal strip into a generally cylindrical, corrugated ring; and
connecting the corrugated ring to the hub to define at least one housing of the clutch.

12. The method of claim 11 further comprising:
joining longitudinal ends of the sheet metal strip to one another to form the generally cylindrical, corrugated ring into a continuous corrugated ring.

13. The method of claim 11 further comprising:
bending tabs on the sheet metal strip to extend radially inwardly when a corrugated ring is formed from the sheet metal strip.

14. The method of claim 13, wherein the connecting step further comprises:
connecting the radially inwardly extending tabs of the corrugated ring to the hub.

15. In a clutch having an outer housing and an inner housing arranged coaxially with respect to one another to support a plurality of first and second alternating, interiorly arranged, radially extending, friction members for axial movement between engaged and disengaged positions, the improvement of the clutch comprising:
an inner housing assembly having a hub and an elongate sheet metal strip having bent tabs and evenly spaced corrugations stamped along an entire longitudinal length of the sheet metal strip, the elongate sheet metal strip wrapped around to form a continuous, generally cylindrical, corrugated ring with inwardly extending bent tabs, the corrugated ring connected to the hub.

16. The improvement of claim 15 further comprising:
at least one rivet attaching a bent tab of the corrugated ring to the hub.

17. The improvement of claim 15 further comprising:
a plurality of teeth formed in an outer circumferential surface of the hub for supporting the corrugated ring when assembled.

18. The improvement of claim 15, wherein the hub includes a plurality of complementary shaped recesses for receiving the bent tabs of the corrugated ring when assembled.

19. The improvement of claim 18 further comprising:
a radially and longitudinally extending rib located between adjacent complementary shaped recesses defining a longitudinal stop for abutment with a longitudinal end of the corrugated ring located between adjacent bent tabs.
